(19) United States
(12) Patent Application Publication
(10) Pub. No.: US 2026/0349147 A1
(43) Pub. Date: Nov. 5, 2026

(54) LAMINATED GLASS, LAMINATED GLASS FOR VEHICLE, AND LAMINATED GLASS FOR VEHICLE ROOF

(71) Applicant: AGC Inc., Tokyo (JP)

(72) Inventors: Hideyuki HIRAKOSO, Tokyo (JP); Aichi INOUE, Tokyo (JP); Soichiro KATO, Tokyo (JP); Ryuji HIRATA, Tokyo (JP); Yuichi SUZUKI, Tokyo (JP)

(73) Assignee: AGC Inc., Tokyo (JP)

(21) Appl. No.: 19/711,878

(22) Filed: Jun. 17, 2026

Related U.S. Application Data
(63) Continuation of application No. PCT/JP2025/000556, filed on Jan. 9, 2025.

(30) Foreign Application Priority Data
Jan. 10, 2024 (JP) 2024-002051

(51) Int. Cl. G02B 1/11

(52) U.S. Cl. CPC G02B 1/11

(57) ABSTRACT

To provide a laminated glass having an antiglare surface, which can suppress reflection of the interior furnishings even when the window glass has low visible light transmittance and a reflection image on the interior side is easily seen, and through which the outdoor scenery can be clearly and sufficiently recognized.

According to an embodiment of the present invention, a laminated glass 100 has an outer sheet 10, an interlayer film 20 and an inner sheet 30 in this order, wherein the inner sheet 30 has an antiglare surface 31 generated by an antiglare treatment on the interior side, and wherein the antiglare surface 31 has an arithmetic mean roughness Ra of 90 nm or more and 170 nm or less.

### CROSS-REFERENCE TO RELATED APPLICATIONS

This application is a continuation of PCT Application No. PCT/JP2025/000556, filed on Jan. 9, 2025, which is based upon and claims the benefit of priority from Japanese Patent Application No. 2024-002051 filed on Jan. 10, 2024. The contents of those applications are incorporated herein by reference in their entireties.

### TECHNICAL FIELD

The present invention relates to a laminated glass, a laminated glass for a vehicle, and a laminated glass for a vehicle roof.

### BACKGROUND ART

It is known that an antiglare treatment is applied to a cover glass surface of a display, reflection of the surroundings on the display can be reduced.

The following Patent Document 1 discloses a technique relating to an antiglare treatment of forming protrusions and recesses on the surface of a glass sheet.

### PRIOR ART DOCUMENTS

### Patent Documents

Patent Document 1: JP-A-2016-040211

### DISCLOSURE OF INVENTION

### Technical Problem

In recent years, reflection of the interior furnishings on a window glass of e.g. an automobile, a building construction, a ship or the like particularly when the window glass has a low visible light transmittance is problematic. By applying an antiglare treatment to the window glass, the reflection of the interior furnishings can be suppressed, however, partial light scattering by the antiglare treatment decreases visibility of the exterior. Particularly in the case of the window glass, an object to be visually recognized is located at a greater distance as compared with a case of a display, so the deterioration of the visibility caused by partial light scattering becomes more remarkable.

Under these circumstances, the object of the present invention is to provide a laminated glass, a laminated glass for a vehicle and a laminated glass for a vehicle roof, each having an antiglare surface, on which reflection of the interior furnishings can be suppressed even when the window glass has a low visible light transmittance and a reflection image in the interior side is easily seen, and through which the outdoor scenery can be clearly and sufficiently recognized.

### Solution to Problem

According to an embodiment of the present disclosure, the laminated glass, the laminated glass for a vehicle, and the laminated glass for a vehicle roof have the following configurations.

[1]

A laminated glass comprising an outer sheet, an interlayer film and an inner sheet in this order, wherein
the inner sheet has an antiglare surface generated by an antiglare treatment on the interior side surface, and
the antiglare surface has an arithmetic mean roughness Ra of 90 nm or more and 170 nm or less.
   [2]

The laminated glass according to [1], wherein the antiglare surface has a mean width Rsm of 35 μm or more and 100 μm or less.

[3]

The laminated glass according to [1] or [2], wherein the visibility index value T of the laminated glass is 80% or more and 95% or less.

[4]

The laminated glass according to any one of [1] to [3], wherein the reflection image diffusiveness index value R of the laminated glass is 5% or more and 55% or less.

[5]

The laminated glass according to any one of [1] to [4], which has two interlayer films and a light control film provided between the two interlayer films.

[6]

The laminated glass according to any one of [1] to [5], which has a low emissivity film on the antiglare surface of the inner sheet,
which has a first dielectric layer and a transparent conductive layer in this order from the antiglare surface side, and
wherein the transparent conductive layer is one selected from an ITO layer, a tin oxide layer, a fluorine-doped tin oxide layer, an antimony-doped tin oxide layer, a silver layer, a zirconium nitride layer and a titanium nitride layer.
   [7]

The laminated glass according to [6], wherein
the vertical emissivity on the surface of the low emissivity film is 0.3 or less.
   [8]

The laminated glass according to [6] or [7], wherein the first dielectric layer contains an oxide or an oxynitride of at least one metal selected from the group consisting of Ti, Nb, Ta, Zn, Al, In, Si and Zr.

[9]

The laminated glass according to any one of [6] to [8], wherein the first dielectric layer has a layer thickness of 20 nm or more and 100 nm or less.

[10]

The laminated glass according to any one of [6] to [9], wherein the transparent conductive layer is an ITO layer, and
the transparent conductive layer has a layer thickness of 50 nm or more and 150 nm or less.
   [11]

The laminated glass according to [10], wherein the low emissivity film has a second dielectric layer on the interior side of the transparent conductive layer, and the second dielectric layer contains an oxide or an oxynitride of at least one metal selected from the group consisting of Ti, Nb, Ta, Zn, Al, In, Si and Zr.

[12]

The laminated glass according to [11], wherein the second dielectric layer has a layer thickness of 50 nm or more and 120 nm or less.

[13]

The laminated glass according to any one of [6] to [9], wherein the transparent conductive layer is a tin oxide layer, and
the transparent conductive layer has a layer thickness of 250 nm or more and 400 nm or less.
   [14]

The laminated glass according to any one of [6] to [9], wherein the transparent conductive layer is a silver layer, and
the transparent conductive layer has a layer thickness of 5 nm or more and 100 nm or less.
   [15]

The laminated glass according to [10], wherein the low emissivity film has a reflection-controlling layer on the interior side of the transparent conductive layer, and
the reflection-controlling layer contains an oxide or an oxynitride of at least one metal selected from the group consisting of Ti, Nb, Ta, Zn, Al, In, Si and Zr.
   [16]

The laminated glass according to any one of [6] to [15], wherein the surface of the low emissivity film has an arithmetic mean roughness Ra of 90 nm or more and 170 nm or less.

[17]

The laminated glass according to any one of [6] to [16], wherein the surface of the low emissivity film has a mean width Rsm of 35 μm or more and 100 μm or less.

[18]

A laminated glass for a vehicle, which comprises the laminated glass as defined in any one of [1] to [17].

[19]

A laminated glass for a vehicle roof, comprising the laminated glass as defined in any one of [1] to [18].

[20]

A laminated glass comprising an outer sheet, an interlayer film and an inner sheet in this order, wherein
the visibility index value T of the laminated glass is 80% or more and 95% or less, and
the reflection image diffusiveness index value R of the laminated glass is 5% or more and 55% or less.

### Advantageous Effects of Invention

According to the present invention, it is possible to provide a laminated glass, a laminated glass for a vehicle and a laminated glass for a vehicle roof, each having an antiglare surface, on which reflection of the interior furnishings can be suppressed even when the window glass has a low visible light transmittance and a reflection image in the interior side is easily seen, and through which the outdoor scenery can be clearly and sufficiently recognized.

### BRIEF DESCRIPTION OF DRAWINGS

FIG. 1 is a cross-sectional view illustrating an example of configuration of a laminated glass according to a first embodiment.

FIG. 2 is a cross-sectional view illustrating an example of configuration of a laminated glass according to a second embodiment.

FIG. 3 is a cross-sectional view illustrating an example of configuration of a laminated glass according to a third embodiment.

### DESCRIPTION OF EMBODIMENTS

Now, embodiments of the present invention will be described with reference to drawings. In each drawing, the same reference symbols are used to denote identical or corresponding elements, and duplicate descriptions may be omitted as appropriate for clarity. In this specification, “to” used to indicate a numerical range includes the numerical values described before and after it as the lower and upper limit values.

### First Embodiment

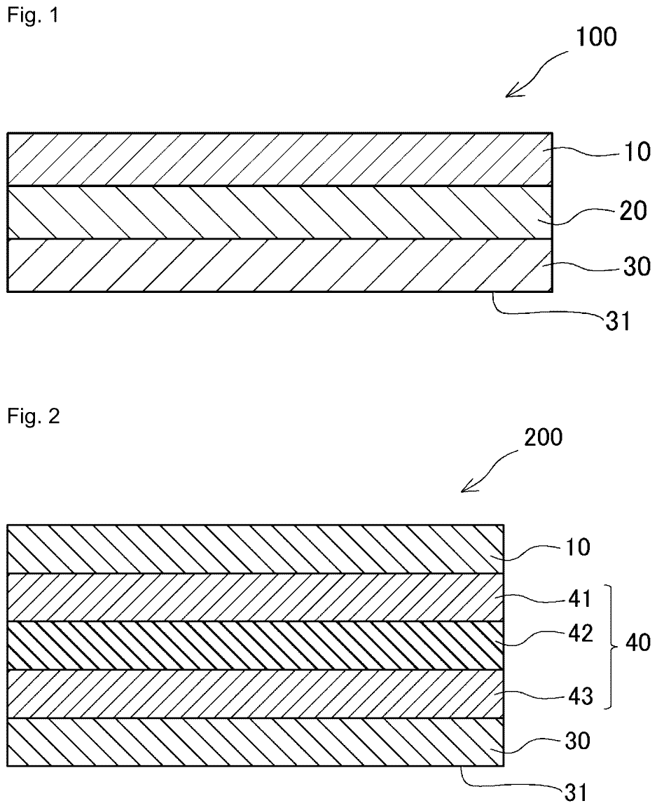

FIG. 1 is a cross-sectional view illustrating an example of configuration of a laminated glass according to a first embodiment. As shown in FIG. 1, the laminated glass 100 according to the first embodiment comprises an outer sheet 10, an interlayer film 20, and an inner sheet 30 in this order.

The laminated glass 100 according to the first embodiment is applicable, for example, to a window glass of an automobile, a building construction, a ship, etc. The laminated glass 100 is suitable for a laminated glass for a vehicle. The laminated glass 100 is particularly suitable for e.g. a laminated glass for a vehicle roof, as it is excellent in visibility. The laminated glass for a vehicle roof is used for a roof of a vehicle. The laminated glass 100 is attached so that the outer sheet 10 side faces the exterior of a vehicle or a room, and that the inner sheet 30 side faces the interior of a vehicle or a room. Hereinafter, “the exterior of a vehicle or a room” may sometimes be referred to simply as “the exterior”, and “the interior of a vehicle or a room” may sometimes be referred to simply as “the interior”.

In FIG. 1, the illustrated laminated glass 100 is in a flat plate shape, but is preferably curved. The curve may be a curve in one direction or in two or more directions. The curve in one direction includes a curve in a lengthwise direction and a curve in a crosswise direction of the laminated glass 100. The curve in two or more directions includes a curve in lengthwise and crosswise directions of the laminated glass 100, and a more complicated curve, that is so-called three dimensional curve. The planar shape of the laminated glass 100 may be any shape including a square and rectangle, a trapezoid, a triangle and the like. The planar shape here refers to a shape of the laminated glass 100 as observed from a normal direction of the surface of the outer sheet 10.

The outer sheet 10 and the inner sheet 30 are glass sheets. The types of the glass constituting the outer sheet 10 and the inner sheet 30 are not particularly limited. The outer sheet 10 and the inner sheet 30 may, for example, be made of soda lime silicate glass, aluminosilicate glass, alkali free glass or borosilicate glass. Each of the outer sheet 10 and the inner sheet 30 is preferably made of soda lime glass or aluminosilicate glass. Particularly, it is more preferred that both the outer sheet 10 and the inner sheet 30 are made of soda lime glass.

Each of the outer sheet 10 and the inner sheet 30 may have, for example, the following composition as represented by percentage based on the total glass weight.
SiO₂: 55 to 85%
Al₂O₃: 0 to 30%
B₂O₃: 0 to 20%
Na₂O: 0 to 25%
CaO: 0 to 20%
MgO: 0 to 15%
K₂O: 0 to 20%
BaO: 0 to 20%

Each of the outer sheet 10 and the inner sheet 30 preferably has the following composition as represented by percentage based on the total glass weight.
SiO₂: 55 to 78%
Al₂O₃: 0 to 18%
B₂O₃: 0 to 18%
Na₂O: 5 to 20%
CaO: 0 to 10%
MgO: 0 to 10%
K₂O: 0 to 10%
BaO: 0 to 5%

Each of the outer sheet 10 and the inner sheet 30 more preferably has the following composition as represented by percentage based on the total glass weight.
SiO₂: 65 to 78%
Al₂O₃: 0 to 6%
B₂O₃: 0 to 4%
CaO: 0 to 10%
MgO: 0 to 10%
Na₂O: 5 to 20%
K₂O: 0 to 10%
BaO: 0 to 5%

Each of the outer sheet 10 and the inner sheet 30 may be made of colorless glass such as clear glass, or may be made of colored glass such as privacy glass. For example, in a case where the inner sheet 30 is made of clear glass, it may have a visible light transmittance of 75% or more. The visible light transmittance of the clear glass may be 80% or more, may be 85% or more, and may be 90% or more. In a case where the inner sheet 30 is made of privacy glass, it may have a visible light transmittance of less than 75%. The degree of coloring is not limited thereto, and a glass sheet having a visible light transmittance of for example 70% or less, 60% or less, 50% or less, 40% or less, or 30% or less may be used. The lower limit of the visible light transmittance of the glass sheet is not particularly limited so long as the exterior is visually recognized from the interior. The visible light transmittance of the glass sheet may be for example 5% or more, 10% or more, 20% or more, and 30% or more. The visible light transmittance is a value measured by the measurement method in accordance with JIS R3212:2015.

The outer sheet 10 may be tempered glass such as physically tempered glass or chemically tempered glass, or may be non-tempered glass. The inner sheet 30 may be tempered glass or non-tempered glass. The tempered glass may be one having a compressive stress layer formed on the surface of non-tempered glass. The stress distribution of the glass surface is not necessarily uniform and may have a pattern, and thus the maximum value of the surface compressive stress may be employed to indicate the degree of tempering. In the present disclosure, physically tempered glass has a maximum surface compressive stress value within a range of 80 MPa to 200 MPa, chemically tempered glass has a maximum surface compressive stress value within a range of 300 MPa to 1000 MPa, and non-tempered glass has a maximum surface compressive stress value within a range of 0 MPa to 50 MPa. The surface compressive stress value may be measured by a glass surface stress meter (for example FSM-7000H manufactured by Orihara Manufacturing Co., Ltd.).

The sheet thicknesses of the outer sheet 10 and the inner sheet 30 may be the same or different from each other. For example, the inner sheet 30 may be thinner than the outer sheet 10. The sheet thickness of the outer sheet 10 is preferably 0.1 mm or more, more preferably 0.5 mm or more, further preferably 1.0 mm or more, particularly preferably 1.5 mm or more, more particularly preferably 2.0 mm or more. The sheet thickness of the outer sheet 10 is preferably 3.0 mm or less, more preferably 2.5 mm or less, preferably 2.0 mm or less. The sheet thickness of the inner sheet 30 is preferably 0.05 mm or more, more preferably 0.3 mm or more, further preferably 0.8 mm or more, particularly preferably 1.3 mm or more, more particularly preferably 1.8 mm or more. The sheet thickness of the inner sheet 30 is preferably 2.8 mm or less, more preferably 2.3 mm or less, preferably 1.8 mm or less.

The inner sheet 30 has an antiglare surface 31 generated by an antiglare treatment on the interior side surface. The antiglare treatment is conducted for example by etching a glass sheet. In a case where the antiglare treatment is conducted by etching a glass sheet, the antiglare surface 31 may be considered as one of the surface portions of the inner sheet 30. That is, the antiglare surface 31 may be considered as being formed by glass constituting the inner sheet 30. With a view to preventing the reflection, the arithmetic mean roughness Ra of antiglare surface 31 is 90 nm or more, preferably 95 nm or more, more preferably 100 nm or more. With a view to obtaining sufficient transmitted image clarity, that is with a view to obtaining a clear transmitted image, the arithmetic mean roughness Ra of the antiglare surface 31 is 170 nm or less, preferably 150 nm or less, more preferably 130 nm or less. The arithmetic mean roughness Ra is a value measured by the method in accordance with JIS B0601:2001 (ISO4287:1997).

With a view to obtaining a clear transmitted image, the mean width Rsm of the antiglare surface 31 is preferably 35 μm or more, more preferably 40 μm or more, further preferably 50 μm or more, particularly preferably 65 μm or more. With a view to suppressing the reflection, the mean width Rsm of the antiglare surface 31 is preferably 100 μm or less, more preferably 95 μm or less, further preferably 90 μm or less. The mean width Rsm is a value measured by the method in accordance with JIS B0601:2001 (ISO4287:1997).

The interlayer film 20 is constituted preferably for example by a transparent resin. The resin constituting the interlayer film 20 may, for example, be polyvinyl butyral (PVB), polyvinyl chloride, ethylene vinyl acetate (EVA), a cycloolefin polymer, a urethane resin, or a polyvinylidene fluoride resin (PVDF). The film thickness of the interlayer film 20 is preferably 0.1 mm or more, more preferably 0.2 mm or more, further preferably 0.3 mm or more. The film thickness of the interlayer film 20 is preferably 2.0 mm or less, more preferably 1.0 mm or less, further preferably 0.7 mm or less. The interlayer film 20 may be colorless or colored. The interlayer film 20 may be colored, for example, by being constituted by a resin containing a coloring agent such as a pigment. The interlayer film 20 may have a sound insulating property. The interlayer film having a sound insulating property may, for example, be a sound insulating interlayer film as described in EP U.S. Pat. No. 1,800,855 or WO2017/204121.

The visibility (clarity) represents the degree to which an image obtained when an object is viewed through a glass sheet matches the actual object, and it has been confirmed to correlate with the observer's visual judgement results on visibility, that is, resolution, to exhibit behavior close to human visual perception. For example, a glass sheet showing a small visibility index value T has poor visibility, whereas a glass sheet showing a large visibility index value T provides good visibility. Therefore, the visibility index value T can be used as a quantitative indicator for evaluating the visibility of a glass sheet.

The visibility index value T is quantified by the following method.

An apparatus for measuring the visibility index value T includes a light source and an analyzing apparatus, and the laminated glass 100 is disposed between the light source and the analyzing apparatus. The laminated glass 100 is disposed at a position 30 mm above a slit white light source having a length of 40 mm and a width of 0.1 mm, so that the inner sheet 30 side that is the antiglare surface 31 side of the laminated glass 100 is located on the light source side. The analyzing apparatus is positioned on the outer sheet 10 side of the laminated glass 100. The light source emit first light parallel to the laminated glass 100 thickness direction from the antiglare surface 31 side toward the laminated glass 100. The analyzing apparatus detects the luminance of transmitted light that is the first light transmitted through the laminated glass 100.

As the analyzing apparatus, SMS-1000 manufactured by DM&S (Display-Messtechnik & Systeme) is used. As a camera lens, a C1614A lens with a focal length of 16 mm is used at an aperture of f5.6. The distance from the antiglare surface 31 of the laminated glass 100 to the camera lens is set to 550 mm. Based on the angle in a direction parallel to the laminated glass 100 thickness direction being θ=0°, the average luminance within a range of the angle θ=0°±0.1° is taken as T1, the average luminance within a range of the angle θ=0.7°±0.1° is taken as T2, and the average luminance within a range of the angle θ=−0.7°±0.1° is taken as T3. In this case, the value calculated in accordance with the following formula (1) will be referred to as the visibility index value T. A minus (−) sign in the angle θ indicates that the angle is tilted counterclockwise with respect to the incident first light, and a plus (+) sign indicates that the angle is tilted clockwise with respect to the incident first light.

Visibility index value T=(1−(T2+T3)/(2×T1))×100 formula (1)

With a view to obtaining a clear transmitted image, the visibility index value T of the laminated glass 100 is preferably 80% or more, more preferably 81% or more, further preferably 83% or more, particularly preferably 85% or more. With a view to preventing the reflection, the visibility index value T of the laminated glass 100 is preferably 95% or less, more preferably 94% or less, further preferably 93% or less. In a case where the laminated glass 100 is used as window glass, the impact on the visibility is small even when the perceived image is coarse, as compared with a case where it is used as display glass. Accordingly, it is considered that the optimal value of the visibility index value T of the laminated glass 100 is low, that is, a region with less straight-line propagation.

The reflection image diffusiveness index value represents the degree to which the reflection image of an object, such as vehicle interior furnishings, placed facing a glass sheet, has the sharpness corresponding to that of the original object, and has been confirmed to correlate with the observer's visual judgement results on the reflection and to exhibit behavior close to human visual perception. For example, a glass sheet exhibiting a small reflection image diffusiveness index value R has poor performance of suppressing the reflection, whereas a glass sheet exhibiting a large reflection image diffusiveness index value R has performance of suppressing the reflection.

The reflection image diffusiveness index value R is quantified by the following method.

An apparatus for measuring the reflection image diffusiveness index value R includes a light source and an analyzing apparatus, and is disposed so that the antiglare surface 31 side of the laminated glass 100 faces the light source and the analyzing apparatus. A black plate is disposed on the outer sheet 10 side of the laminated glass 100. The light source emits second light in the form of a slit having a 101 mm width toward the laminated glass 100. The second light is applied onto the laminated glass 100 at an angle inclined 5.7° clockwise, where the direction normal to the laminated glass 100, that is, the direction parallel to the glass sheet thickness direction, is defined as angle φ=0°. Since actual measurements include errors, the angle q more precisely encompasses a range of 5.7°±0.1°. The analyzing apparatus receives reflected light reflected from the antiglare surface 31 at a predetermined angle and analyzes the luminance thereof.

As the analyzing apparatus, SMS-1000 manufactured by DM&S (Display-Messtechnik & Systeme) is used. As a camera lens, a C1614A lens with a focal length of 16 mm is used at an aperture of f5.6. The distance from the antiglare surface 31 of the laminated glass 100 to the camera lens is set to 300 mm, and the imaging scale is set to a range of 0.0276 to 0.0278. Based on the angle in a direction parallel to the laminated glass 100 thickness direction being φ=0°, light is emitted from an angle of φ=5.7°±0.1°, and the angle at total reflection φ=−5.7° is taken as the reference that is α=0°. The average luminance within a range of the angle α=0°±0.1° is taken as R1, the average luminance within a range of the angle α=0.5°±0.1° is taken as R2, and the average luminance within a range of the angle α=−0.5°±0.1° is taken as R3. In this case, the value calculated in accordance with the following formula (2) will be referred to as the reflection image diffusiveness index value R. A minus (−) sign indicates that the angle is tilted counterclockwise with respect to the normal of the laminated glass 100, and a plus (+) sign indicates that the angle is tilted clockwise with respect to the normal of the laminated glass 100.

Reflection image diffusiveness index value R=(R2+R3)/(2×R1)×100 formula (2)

With a view to preventing the reflection, the reflection image diffusiveness index value R of the laminated glass 100 is preferably 5% or more, more preferably 10% or more, further preferably 15% or more, particularly preferably 20% or more. With a view to obtaining a clear transmitted image, the reflection image diffusiveness index value R of the laminated glass 100 is preferably 55% or less, more preferably 50% or less, further preferably 45% or less. In a case where the laminated glass 100 is used as window glass, the impact on the visibility is small even when the perceived image is coarse, as compared with a case where it is used as display glass. Accordingly, it is considered that the optimal value of the reflection image diffusiveness index value R of the laminated glass 100 is high, that is, a region with more scattering.

On the main surface of at least one of the outer sheet 10 and the inner sheet 30, coating films with various functions may be provided. For example, the outer sheet 10 may have a heat reflecting film such as an infrared reflecting film or an infrared absorbing film on the interior side surface, that is on the interlayer film 20 side surface. The infrared reflecting film reflects selectively infrared rays to prevent the temperature increase in the interior, and prevents thermal deterioration of e.g. the interlayer film 20. The infrared reflecting film may be constituted by a plurality of layers. The infrared reflecting film may have such a configuration that at least one of the plurality of layers contains an infrared reflecting material. The infrared reflecting material is a material which reflects infrared rays and may, for example, be silver (Ag), a transparent conductive oxide such as indium tin oxide or zinc oxide, fluorine-doped tin oxide, or another optional material which blocks an adequate amount of infrared rays. The infrared reflecting film may have a configuration, for example, having a layer containing a dielectric (a dielectric layer) and a layer containing Ag (a Ag layer). The dielectric may, for example be silicon nitride, titanium oxide, silicon oxynitride, tin oxide, other metal (alloy) oxide or other metal (alloy) nitride. Examples of other metal oxide include zinc tin oxide, aluminum zinc oxide, nickel chromium oxide, silver oxide and zinc oxide. The infrared reflecting film may have a configuration such that a Ag layer is sandwiched between a pair of dielectric layers.

Further, the infrared reflecting film may contain a plurality of Ag layers. With a view to obtaining sufficient infrared reflection property and with a view to suppressing the production cost, the infrared reflecting film preferably has two, three or four Ag layers. In a case where the infrared reflecting film has two Ag layers, it preferably has a configuration such that from the outer sheet 10 side, it has a plurality of dielectric layers, a Ag layer, a plurality of dielectric layers, a Ag layer and a plurality of dielectric layers. In a case where the infrared reflecting film has three Ag layers, it preferably has a configuration such that from the outer sheet 10 side, it has a plurality of dielectric layers, a Ag layer, a plurality of dielectric layers, a Ag layer, a plurality of dielectric layers, a Ag layer and a plurality of dielectric layers. In a case where the infrared reflecting film has four Ag layers, it preferably has a configuration such that from the outer sheet 10 side, it has a plurality of dielectric layers, a Ag layer, a plurality of dielectric layers, a Ag layer, a plurality of dielectric layers, a Ag layer, a plurality of dielectric layers, a Ag layer and a plurality of dielectric layers. The plurality of dielectric layers are layers different in the dielectric contained or in the composition ratio of the dielectrics.

In a case where the infrared reflecting film has two Ag layers, the film thickness of the infrared reflecting film is preferably 500 nm or less, more preferably 400 nm or less, particularly preferably 300 nm or less, more particularly preferably 250 nm or less. In a case where the infrared reflecting film has two Ag layers, the film thickness of the infrared reflecting film is preferably 50 nm or more, more preferably 100 nm or more, particularly preferably 150 nm or more. In a case where the infrared reflecting film has three Ag layers, the film thickness of the infrared reflecting film is preferably 600 nm or less, more preferably 500 nm or less, particularly preferably 400 nm or less, more particularly preferably 350 nm or less. In a case where the infrared reflecting film has three Ag layers, the film thickness of the infrared reflecting film is preferably 100 nm or more, more preferably 150 nm or more, particularly preferably 200 nm or more, more particularly preferably 250 nm or more. In a case where the infrared reflecting film has four Ag layers, the film thickness of the infrared reflecting film is preferably 700 nm or less, more preferably 600 nm or less, particularly preferably 500 nm or less, more particularly preferably 450 nm or less. In a case where the infrared reflecting film has four Ag layers, the film thickness of the infrared reflecting film is preferably 150 nm or more, more preferably 200 nm or more, particularly preferably 250 nm or more, more particularly preferably 300 nm or more.

The outer sheet 10 may have a self-cleaning coating on the exterior side surface. The self-cleaning coating is a coating that suppresses attachment of organic substances and inorganic substances to the surface, or a coating from which organic substances of inorganic substances attached to the surface can readily be removed by cleaning such as wiping. With a view to obtaining the above effects, the self-cleaning coating is provided preferably on the outermost surface on the exterior side of the outer sheet 10. The self-cleaning coating is not particularly limited so long as it can impart self-cleaning property and may, for example, be a fluorinated organic silicon compound coating obtained by curing a fluorinated organic silicon compound by hydrolytic condensation reaction, or may be a non-fluorinated organic silicon coating obtained by curing a non-fluorinated organic silicon compound containing no fluorine atom by hydrolytic condensation reaction.

In a case where the self-cleaning coating is a fluorinated organic silicon compound coating, the coating thickness of the self-cleaning coating is preferably 0.1 to 20 nm, more preferably 1 to 15 nm, further preferably 2 to 10 nm. When the self-cleaning coating has a coating thickness of 2 nm or more, the glass substrate is uniformly covered with the self-cleaning coating, and practical applicability from the view point of abrasion resistance is demonstrated. When the self-cleaning coating has a coating thickness of 20 nm or less, favorable optical properties in a state where the self-cleaning coating is provided are achieved. In a case where the self-cleaning coating is a non-fluorinated organic silicon compound coating, the coating thickness of the self-cleaning coating is preferably larger than that of the case where the self-cleaning coating is fluorinated organic silicon compound coating, and is preferably, for example, 0.1 to 30 nm.

The inner sheet 30 may have a water repellent coating on the exterior side surface. The water repellent coating is a coating having high water repellency. The water repellent coating may be formed of e.g. a fluorinated organic compound or a fluorinated resin, or a silicone-containing organic compound or a silicone resin. More specifically, it is formed of a fluorinated organic silicon compound or a hydrolysable fluorinated organic compound, or a silicone resin modified with a hydrolysable silyl group. With a view to achieving water repellent effects, the coating thickness of the water repellent coating is preferably 0.1 nm or more, more preferably 1 nm or more. From the viewpoint of productivity, the coating thickness of the water repellent coating is preferably 10 nm or less. When the inner sheet 30 has the water repellent coating, attachment of stains to the antiglare surface or the like can be suppressed and the attached stains can readily be removed. Further, when the inner sheet 30 has the water repellent coating, as the surface is slippery, the protrusions and the recesses of the antiglare surface are likely to be maintained even when the antiglare surface is rubbed with a cloth or the like.

### Second Embodiment

In the first embodiment, the laminated glass having a single-layer interlayer film was described. However, the present invention is applicable also to a laminated glass having a multi-layer interlayer film and/or functional sheet. In the second embodiment, a laminated glass having a multilayer interlayer film and functional sheet will be described. FIG. 2 is a cross-sectional view illustrating an example of configuration of a laminated glass according to the second embodiment. As shown in FIG. 2, a laminated glass 200 according to the second embodiment has an outer sheet 10, an interlayer film 40, and an inner sheet 30 in this order. The outer sheet and the inner sheet 30 which the laminated glass 200 has are the same as those described in the first embodiment and their description is omitted. The interlayer film 40 has a first interlayer film 41, a light control sheet 42, and a second interlayer film 43 in this order. The configurations of the first interlayer film 41 and the second interlayer film 43 are the same as that of the interlayer film 20 described in the first embodiment and their description is omitted. The light control sheet 42 has a light control function to change the light transmission state depending upon the voltage applied. The light control sheet 42 can reversibly control visible light and infrared transmission of the laminated glass 200 by controlling the voltage applied. The transmission state may be represented for example by the visible light transmittance or the haze.

As the light control sheet 42, a suspended particle device (SPD), a polymer dispersed liquid crystal (PDLC), a polymer network liquid crystal (PNLC), a guest-host liquid crystal (GHLC), a TN (twisted nematic) liquid crystal, a PC (phase change) liquid crystal, a STN (super twisted nematic) liquid crystal, an ECB (electrically controlled birefringence) liquid crystal, an OCB (optically compensated bend) liquid crystal, an IPS (in-plane switching) liquid crystal, a VA (vertical alignment) liquid crystal, a FFS (fringe field switching) liquid crystal, a FPA (field-induced photo-reactive alignment) liquid crystal, an electrochromic device, an electrokinetic device, an organic EL (electro-luminescence) device, an inorganic EL device, or the like may be used. As the light control sheet 42, among them, a SPD, a PDLC, a PNLC, a GHLC, a TN liquid crystal, a PC liquid crystal, a STN liquid crystal, an ECB liquid crystal, an OCB liquid crystal, an IPS liquid crystal, a VA liquid crystal, a FFS liquid crystal, a FPA liquid crystal, and an electrochromic device are suitable used.

When the visibility index value T and the reflection image diffusiveness index value R of the laminated glass 100 are measured, the light control sheet 42 is turned off. “The light control sheet 42 is turned off” means to minimize the parallel light transmittance of the laminated glass 200 by adjusting the voltage applied to the light control sheet 42. In other words, “the light control sheet 42 is turned off” means to make the laminated glass 10 into a state in which light can least travel straight through.

### Third Embodiment

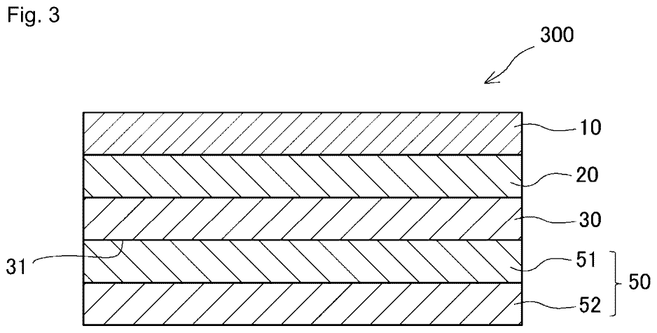

The present invention is applicable also to a laminated glass having a low emissivity film on the interior side surface of the inner sheet 30. The present invention is also applicable to a laminated glass having the light control sheet and having a low emissivity film on the interior side surface of the inner sheet 30. Now, with reference to FIG. 3, a laminated glass having no light control sheet and having a low emissivity film will be described. FIG. 3 is a cross-sectional view illustrating an example of configuration of a laminated glass according to the third embodiment. As shown in FIG. 3, a laminated glass 300 according to the third embodiment has an outer sheet 10, an interlayer film 20, an inner sheet 30 and a low emissivity film 50 in this order. The inner sheet 30 has the low emissivity film 50 on an antiglare surface 31. In other words, the low emissivity film 50 is in contact with the antiglare surface 31. The outer sheet 10, the interlayer film 20 and the inner sheet 30 which the laminated glass 300 has are the same as those described in the first embodiment, and their description is omitted. The low emissivity film 50 may have a first dielectric layer 51, a transparent conductive layer 52 and other layer. In the example shown in FIG. 3, a case in which the low emissivity film 50 has the first dielectric layer 51 and the transparent conductive layer 52 will be described.

The vertical emissivity on the surface of the low emissivity film 50 that is on the interior side surface, is 0.3 or less, preferably 0.25 or less, more preferably 0.2 or less, further preferably 0.15 or less. The vertical emissivity on the exterior side surface of the low emissivity film 50 is preferably 0.1 or more. The vertical emissivity may be a value measured by a handy simplified emissivity meter. The ambient temperature at the time of measurement is adjusted to room temperature of °C. The simplified emissivity meter measures the resistance and estimates the emissivity from an analytical curve of the resistance and the emissivity. The vertical emissivity may also be a value measured by FTIR (Fourier Transform Infrared Spectroscopy) apparatus evaluating by cut glass. The FTIR apparatus measures the absorbance at each wavelength and obtains the vertical emissivity.

The first dielectric layer 51 preferably contains an oxide or an oxynitride of at least one metal selected from the group consisting of Ti, Nb, Ta, Zn, Al, In, Si and Zr. The layer thickness of the first dielectric layer 51 is 20 nm or more, more preferably nm or more, further preferably 30 nm or more. The layer thickness of the first dielectric layer 51 is preferably 100 nm or less, more preferably 90 nm or less, further preferably 80 nm or less.

The transparent conductive layer 52 is preferably an ITO (indium tin oxide) layer, a tin oxide layer, a fluorine-doped tin oxide layer, an antimony-doped tin oxide layer, a silver layer, a zirconium nitride layer or a titanium nitride layer. The transparent conductive layer 52 may contain an additive. In a case where the transparent conductive layer 52 is an ITO layer, the additive may, for example, be Ga, Zn, Al and/or Nb. In a case where the transparent conductive layer 52 is an ITO layer, with a view to reducing the resistance, the proportion of tin oxide contained in the ITO layer is preferably 5 mass % or more and 12.5 mass % or less, more preferably 6.5 mass % or more and 11 mass % or less. The ITO layer may contain, in addition to ITO, other material in an amount less than 50 mass %. The other material contained in the ITO layer may, for example, be sodium, lead and/or iron.

In a case where the transparent conductive layer 52 is an ITO layer, the layer thickness of the transparent conductive layer 52 is preferably 80 nm or more, more preferably 100 nm or more, further preferably 110 nm or more. In a case where the transparent conductive layer 52 is an ITO layer, the layer thickness of the transparent conductive layer 52 is preferably 150 nm or less, more preferably 140 nm or less, further preferably 130 nm or less.

In a case where the transparent conductive layer 52 is an ITO layer, the low emissivity film 50 may have a second dielectric layer on the transparent conductive layer 52 that is on the interior side surface. The second dielectric layer preferably contains an oxide or an oxynitride of at least one metal selected from the group consisting of Ti, Nb, Ta, Zn, Al, In, Si and Zr. The layer thickness of the second dielectric layer is preferably 40 nm or more, more preferably 45 nm or more, further preferably 50 nm or more. The layer thickness of the second dielectric layer is preferably 120 nm or less, more preferably 110 nm or less, further preferably 100 nm or less.

In a case where the transparent conductive layer 52 is a tin oxide layer such as a fluorine-doped tin oxide layer or an antimony-doped tin oxide layer, the layer thickness of the transparent conductive layer 52 is 250 nm or more, preferably 280 nm or more. In a case where the transparent conductive layer 52 is a tin oxide layer, the layer thickness of the transparent conductive layer 52 is 400 nm or less, preferably 350 nm or less.

In a case where the transparent conductive layer 52 is a silver layer, the layer thickness of the transparent conductive layer 52 is 5 nm or more, preferably 10 nm or more. In a case where the transparent conductive layer 52 is a silver layer, the layer thickness of the transparent conductive layer 52 is 100 nm or less, preferably 50 nm or less.

With a view to suppressing the reflection, the arithmetic mean roughness Ra of the surface of the low emissivity film 50 is 90 nm or more, preferably 95 nm or more, more preferably 100 nm or more. With a view to obtaining a clear transmitted image, the arithmetic mean roughness Ra of the surface of the low emissivity film 50 is 170 nm or less, preferably 150 nm or less, more preferably 130 nm or less. The arithmetic mean roughness Ra is a value measured by the method in accordance with JIS B0601:2001 (ISO4287:1997).

With a view to obtaining a clear transmitted image, the mean width Rsm of the surface of the low emissivity film 50 is preferably 35 μm or more, more preferably 40 μm or more, further preferably 50 μm or more, particularly preferably 65 μm or more. With a view to suppressing the reflection, the mean width Rsm of the surface of the low emissivity film 50 is preferably 100 μm or less, more preferably 95 μm or less, further preferably 90 μm or less. The mean width Rsm is a value measured by the method in accordance with JIS B0601:2001 (ISO4287:1997).

The low emissivity film 50 may have a reflection-controlling layer on the interior side of the transparent conductive layer 52. In a case where the low emissivity film 50 has the second dielectric layer, the reflection-controlling layer may be provided on the interior side of the second dielectric layer. The reflection-controlling layer preferably contains an oxide or an oxynitride of at least one metal selected from the group consisting of Ti, Nb, Ta, Zn, Al, In, Si and Zr.

The low emissivity film 50 may have a color-correction layer between the inner sheet 30 and the transparent conductive layer 52. The color-correction layer may contain an oxide or an oxynitride of at least one metal selected from the group consisting of Ti, Nb, Ta, Zn, Al, In, Si and Zr. The color-correction layer may be constituted by a plurality of layers containing a first layer and a second layer from the inner sheet 30 side.

The low emissivity film 50 may have an adhesion-improving layer between the transparent conductive layer 52 and the reflection-controlling layer. The adhesion-improving layer is preferably constituted by a metal oxide such as tin oxide, zinc oxide or cerium oxide.

### EXAMPLES

Now, the present invention will be described with reference to Examples.

A sample of a laminated glass was prepared as follows as the sample in each Ex.

First, a 1.9 mm-thick glass sheet was washed with an aqueous cleaning agent and dried. The size of the glass sheet was 100 mm×100 mm. In order for protection during the etching process, a tape was attached to one side of the glass sheet. Then, the glass sheet was dipped in 200 mL of an acid etching solution at to 25 °C for a predetermined time. Finally, the glass sheet was taken out and immediately washed with an aqueous cleaning agent. The composition of the glass sheet used was as follows.
SiO₂: 72 mass %
Al₂O₃: 1.4 mass %
Na₂O: 13 mass %
CaO: 7.9 mass %
MgO: 4.5 mass %
K₂O: 0.2 mass %

The conditions for the chemical etching treatment on each sample are shown in Table 1. The samples in Ex. 9 and 10 were not subjected to the chemical etching treatment.

TABLE 1
Table 1

| | KHF2 | SnCl3 | HF | HNO3 | |
|---|---|---|---|---|---|
| | [mol/L] | [mol/L] | [mol/L] | [mol/L] | Etching time |
| Ex. 1 | 1.5 | 0.25 | 1.5 | 0.5 | 155 |
| Ex. 2 | 2.5 | 0.25 | 2.5 | 0.5 | 95 |
| Ex. 3 | 2 | 0.25 | 2 | 0.5 | 100 |
| Ex. 4 | 1.5 | 0.25 | 2 | 0.5 | 85 |
| Ex. 5 | 1.5 | 0.25 | 1.5 | 0.5 | 80 |
| Ex. 6 | 1.5 | 0.25 | 2.5 | 0.5 | 80 |
| Ex. 7 | 3 | 0.25 | 2 | 0.5 | 100 |
| Ex. 8 | 2.5 | 0.25 | 2.5 | 0.5 | 105 |
| Ex. 9 | — | — | — | — | — |
| Ex. 10 | — | — | — | — | — |
| Ex. 11 | 2 | 0.25 | 2 | 0.5 | 100 |
| Ex. 12 | 2 | 0.25 | 2 | 0.5 | 100 |

Then, with respect to the samples in Ex. 9 and 10, on an inner sheet without chemical etching treatment, a low emissivity film was formed. With respect to the samples in Ex. 11 and 12, on the chemically etched inner sheet, a low emissivity film was formed. Specifically, on the inner sheet (on the chemically etched side surface in Ex. 11 and 12), a Si-containing ZrO2 (Si amount: 5 mass %: ZSO) (refractive index at a wavelength of 630 nm: 2.12) layer was formed as a first layer of a color-correction layer. Then, by sputtering method, on the Zr-containing SiO2 layer, a SiO2 layer was formed as a second layer of the color-correction layer. Then, by sputtering method, on the color-correction layer, an ITO layer was formed as a transparent conductive layer. At the time of layer forming, the inner sheet was not heated. By such an operation, an amorphous ITO layer was obtained. Then, by sputtering method, on the ITO layer, a SiO2 layer was formed as a transparent conductive layer. Then, the inner sheet was heated at 650 °C for 7 minutes.

The layer thicknesses of the layers in the low emissivity film in the samples in Ex. 9 to 12 are shown in the following Table 2.

TABLE 2
Table 2

| | ZSO | SiO2 | ITO | SiO2 | |
|---|---|---|---|---|---|
| | Color- | Color- | Transparent | Reflection- | |
| | correction | correction | conductive | controlling | |
| | layer | layer | layer | layer | Emissivity |
| Ex. 9 | 14 | 35 | 120 | 60 | 0.2 |
| Ex. 10 | 14 | 35 | 120 | 25 | 0.2 |
| Ex. 11 | 14 | 35 | 120 | 60 | 0.2 |
| Ex. 12 | 14 | 35 | 120 | 25 | 0.2 |

Using a glass sheet not chemically etched, that is an outer sheet, the inner sheet and an interlayer film, a laminated glass was prepared. The interlayer film used was SL47-5202 manufactured by Eastman Chemical Company. In such a manner, a laminated glass sample in each of Ex. 1 to 12 was obtained. Ex. 1 to 2 and 9 to 10 are Comparative Examples, and Ex. 3 to 8 and 11 to 12 are Examples of the present invention. To evaluate the samples thus prepared, measurement and sensitivity test were conducted.

### <Measurement>

As an analyzing apparatus, SMS-1000 manufactured by DM&S (Display-Messtechnik & Systeme) was used to measure the visibility index value T and the reflection image diffusiveness index value R. As the arithmetic mean roughness Ra, by the method in accordance with JIS B0601:2001 (ISO4287:1997), the arithmetic mean roughness Ra and the mean width Rsm were measured.

### <Sensitivity Test>

Clarity of the transmitted image viewed through the laminated glass from the interior side, was evaluated sensorially on the following 3-point scale.
1: No transmitted image visually recognized
2: Transmitted image visually recognized but not clearly
3: Transmitted image visually recognized clearly

The reflection of the interior furnishings on the laminated glass when the laminated glass is viewed from the interior side was evaluated sensorially on the following 4-point scale.
1: Boundary of the reflected image visually recognized definitely
2: Boundary of the reflected image visually recognized but not definitely
3: Boundary of the reflected image not visually recognized
4: No reflected image visually recognized

In the following Table 3, the measurement results and the sensitivity test results with respect to the samples in Ex. 1 to 12 are shown.

TABLE 3

| | | Reflection image | | | | |
|---|---|---|---|---|---|---|
| | Visibility index | diffusiveness | Ra | Rsm | Transmitted | |
| Table 3 | value T (%) | index value R (%) | [nm] | [μm] | image clarity | Reflection |
| Ex. 1 | 74 | 72 | 257 | 130 | 1 | 4 |
| Ex. 2 | 98 | 1.1 | 85 | 23 | 3 | 1 |
| Ex. 3 | 88 | 36 | 120 | 65 | 3 | 4 |
| Ex. 4 | 84 | 32 | 148 | 28 | 2 | 4 |
| Ex. 5 | 92 | 37 | 115 | 87 | 3 | 4 |
| Ex. 6 | 89 | 19 | 130 | 20 | 2 | 3 |
| Ex. 7 | 91 | 26 | 96 | 66 | 3 | 3 |
| Ex. 8 | 83 | 43 | 138 | 60 | 2 | 4 |
| Ex. 9 | 99 | 0.01 | 15 | 140 | 3 | 1 |
| Ex. 10 | 99 | 0.01 | 13 | 140 | 3 | 1 |
| Ex. 11 | 87 | 39 | 135 | 65 | 3 | 4 |
| Ex. 12 | 86 | 37 | 130 | 65 | 3 | 4 |

As shown in Table 3, with respect to the samples of Ex. 3 to 8 and 11 to 12, the arithmetic mean roughness Ra of the antiglare surface was 90 to 170 nm. Further, with respect to the samples of Ex. 3 to 8 and 11 to 12, the visibility index value T was 80 to 95%, and the reflection image diffusiveness index value R was 5 to 55%. With respect to the samples of Ex. 3 to 8 and 11 to 12, the transmitted image clarity was rated 2 or higher, such being favorable. With respect to the samples in Ex. 3 to 8 and 11 to 12, the reflection was rated 2 or higher, such being favorable.

As shown in Table 3, with respect to the samples of Ex. 3, 5, 7 to 8 and 11 to 12, the mean width Rsm of the antiglare surface was 35 to 100 μm. With respect to the sample of Ex. 3, 5, 7 and 11 to 12, the transmitted image clarity was rated 3, such being particularly favorable.

The present invention has been described above with reference to the embodiments, however, it should be understood that the present invention is by no means restricted to the above specific embodiment. It is obvious for the person skilled in the art that various changes, modifications and combinations are possible without departing from the intension and the scope of the present invention.

### REFERENCE SYMBOLS

100, 200, 300: laminated glass
10: outer sheet
30: inner sheet
31: antiglare surface
20, 40: interlayer film
41: first interlayer film
42: light control sheet
43: second interlayer film
50: low emissivity film
51: first dielectric layer
52: transparent conductive layer

What is claimed is:

1. A laminated glass comprising an outer sheet, an interlayer film and an inner sheet in this order, wherein
the inner sheet has an antiglare surface generated by an antiglare treatment on the interior side surface, and
the antiglare surface has an arithmetic mean roughness Ra of 90 nm or more and 170 nm or less.

2. The laminated glass according to claim 1, wherein the antiglare surface has a mean width Rsm of 35 μm or more and 100 μm or less.

3. The laminated glass according to claim 1, wherein the antiglare surface has a mean width Rsm of 20 μm or more and 87 μm or less.

4. The laminated glass according to claim 1, wherein the visibility index value T of the laminated glass is 80% or more and 95% or less.

5. The laminated glass according to claim 1, wherein the reflection image diffusiveness index value R of the laminated glass is 5% or more and 55% or less.

6. The laminated glass according to claim 1, which has two interlayer films and a light control sheet provided between the two interlayer films.

7. The laminated glass according to claim 1, which has a low emissivity film on the antiglare surface of the inner sheet,
which has a first dielectric layer and a transparent conductive layer in this order from the antiglare surface side, and
wherein the transparent conductive layer is one selected from an ITO layer, a tin oxide layer, a fluorine-doped tin oxide layer, an antimony-doped tin oxide layer, a silver layer, a zirconium nitride layer and a titanium nitride layer.

8. The laminated glass according to claim 7, wherein
the vertical emissivity on the surface of the low emissivity film is 0.3 or less.

9. The laminated glass according to claim 7, wherein the first dielectric layer contains an oxide or an oxynitride of at least one metal selected from the group consisting of Ti, Nb, Ta, Zn, Al, In, Si and Zr.

10. The laminated glass according to claim 7, wherein the first dielectric layer has a layer thickness of 20 nm or more and 100 nm or less.

11. The laminated glass according to claim 7, wherein the transparent conductive layer is an ITO layer, and
the transparent conductive layer has a layer thickness of 50 nm or more and 150 nm or less.

12. The laminated glass according to claim 11, wherein the low emissivity film has a second dielectric layer on the interior side of the transparent conductive layer, and
the second dielectric layer contains an oxide or an oxynitride of at least one metal selected from the group consisting of Ti, Nb, Ta, Zn, Al, In, Si and Zr.

13. The laminated glass according to claim 12, wherein the second dielectric layer has a layer thickness of 50 nm or more and 120 nm or less.

14. The laminated glass according to claim 7, wherein the transparent conductive layer is a tin oxide layer, and
the transparent conductive layer has a layer thickness of 250 nm or more and 400 nm or less.

15. The laminated glass according to claim 7, wherein the transparent conductive layer is a silver layer, and
the transparent conductive layer has a layer thickness of 5 nm or more and 100 nm or less.

16. The laminated glass according to claim 11, wherein the low emissivity film has a reflection-controlling layer on the interior side of the transparent conductive layer, and
the reflection-controlling layer contains an oxide or an oxynitride of at least one metal selected from the group consisting of Ti, Nb, Ta, Zn, Al, In, Si and Zr.

17. The laminated glass according to claim 7, wherein the surface of the low emissivity film has an arithmetic mean roughness Ra of 90 nm or more and 170 nm or less.

18. The laminated glass according to claim 7, wherein the surface of the low emissivity film has a mean width Rsm of 35 μm or more and 100 μm or less.

19. A laminated glass for a vehicle, which comprises the laminated glass as defined in claim 1.

20. A laminated glass for a vehicle roof, comprising the laminated glass as defined in claim 1.

21. A laminated glass comprising an outer sheet, an interlayer film and an inner sheet in this order, wherein
the visibility index value T of the laminated glass is 80% or more and 95% or less, and
the reflection image diffusiveness index value R of the laminated glass is 5% or more and 55% or less.
